(19) United States
(12) Patent Application Publication
(10) Pub. No.: US 2007/0097310 A1
(43) Pub. Date: May 3, 2007

(54) DISPLAY DEVICE AND METHOD FOR MANUFACTURING A DISPLAY DEVICE

(75) Inventors: Paulus Cornelis DUINEVELD, Drachten (NL); Peter Jan SLIKKERVEER, Eindhoven, NL (NL); Ronald VAN RIJSWIJK, Eindhoven (NL); Adriaan Yde RAAP, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,839

(22) PCT Filed: Dec. 20, 2004
(86) PCT No.: PCT/IB04/52859

§ 371 Date: Jun. 27, 2006

(30) Foreign Application Priority Data
Jan. 13, 2004 (EP) 04100085.2

(51) Int. Cl. G02F 1/1339

(52) U.S. Cl. 349/155

(57) ABSTRACT

The function of the barriers (7) used for ink-jet printing and spacers are combined at the inner side of a display (1), which saves a mask step.

The invention relates to a display device comprising an electro-optical medium between a pair of substrates arranged in opposite relation with respect to each other by spacer means.

The display device usually is a device, in which the electro-optical medium is a liquid crystal display device, but other electro-optical media are not excluded and the invention consequently also relates to e.g. electrophoretic devices or any other display device in which spacer means are present.

Such display devices are used in, for example portable apparatuses such as laptop computers, notebook computers and telephones.

In color displays usually a color filter was used which is e.g. made by laborious lithographic techniques, which makes those color filters very expensive.

New inkjet techniques have been developed, which have the advantage of fast processing (throughput time) and low use of (expensive) coloring materials (ink). In this technique barriers are used. A lithographic step is used for making the barriers to allow accurate positioning of the coloring materials (ink). The topology of the barriers (0.5-10 micron high) requires an additional planarization step before the coloring materials can be used in the liquid crystal display device.

On the other hand spacers are used to keep the liquid crystal display material at a fixed distance between the two substrates. The height of the spacers is typically about 5-10 μm, while the height of barriers for ink-jet printing can be 0.5-10 μm. If glass spacers are used and the surface of the applied coloring materials is not flat this may lead to variations in the liquid crystal layer, which variations cause optical deficiencies.

Spacers may also be applied by means of a lithographic or printing process. In this case two manufacturing (mask) steps are necessary to make both the barriers for ink-jet printing and the spacers for the liquid crystal material.

In order to overcome these problems a device according to the invention is provided with coloring materials within areas separated from each other by spacer means

By making the barriers for the inkjet printing substantially (or half of the height in special processeses) equal to the required LC cell gap plus the thickness of the color filter the barrier structure also functions as a spacing structure. This has the advantage that one manufacturing step (including a mask step) can be deleted and also that the barriers for the ink-jet printing do not need to be protected. Also the need for a planarisation layer no longer exists.

Preferably said spacer means comprise a two-part structure. In this case the part of the two-part structure at the substrate provided with coloring materials may comprise opaque material. The single layer could also be opaque. By choosing a suitable geometry the spacing means also form a black mask in this case.

In a further embodiment of the invention a conducting coloring material is chosen. In this way the function of the color filter and an electrode, which is usually indium-tin oxide (ITO) or polyaniline (PANI) or poly-3,4-ethylenedioxythiophene (PEDOT) can be combined and the color filter material does not need to be printed on top of the ITO-electrode.

Some (low) conductivity would also be an advantage when printed on a well conductive electrode like ITO, since it will prevent a voltage drop over the colour filter, preventing higher addressing voltages than when the colour filter is below the electrode.

A further embodiment comprises a sealing edge and a barrier between a filling opening at one edge of the display device and a part between the part of the substrate provided with coloring materials and the other edges. In the latter part a higher cell-gap exists, which makes the flow of liquid crystal material easier. The barrier prevents the liquid from spreading out of the area comprising the printed channels. The filling with the LCD liquid can be done with the normal vacuum filling process (or capillary filling).

A method for manufacturing a display device according to the invention comprises the steps of
a) providing spacer means on a first substrate separating different areas from each other
b) supplying a coloring material to at least one area
c) providing a second substrate on the spacer means.

These and other aspects of the invention will now be elucidated with reference to some non-restricting embodiments and the drawing in which

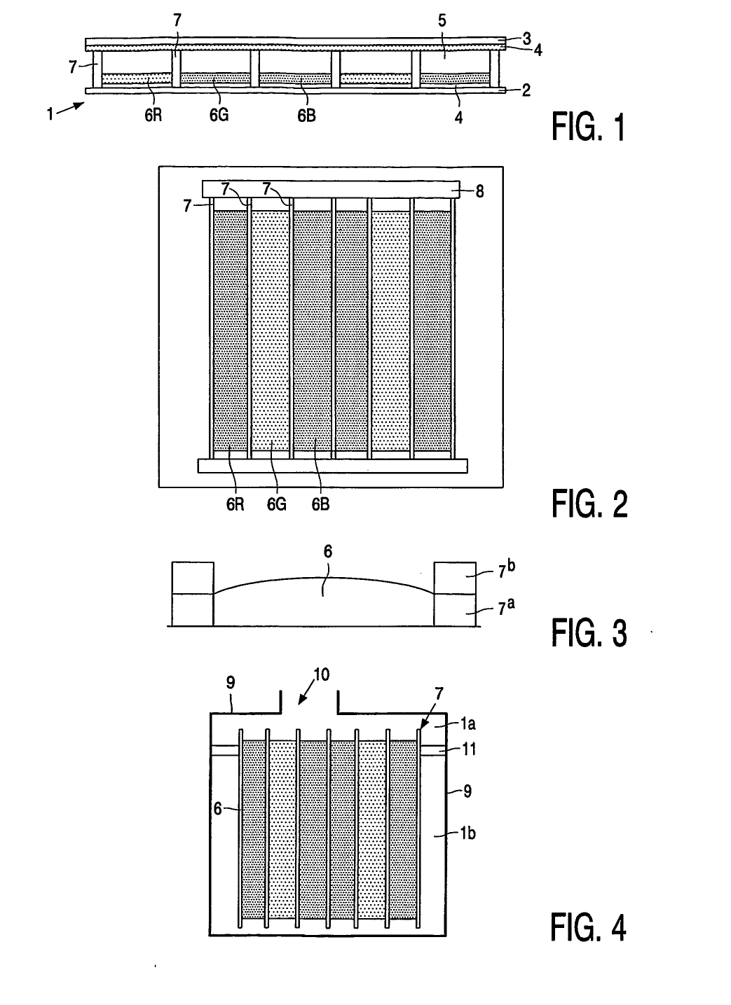

FIG. 1 shows a cross-section of a part of a display device, in which the invention is used, while

FIG. 2 shows a plan view of such a display device, while

FIG. 3 shows a cross-section of a part of another display device, in which the invention is used and

FIG. 4 shows a plan view of a further display device

The Figures are diagrammatic and not drawn to scale. Corresponding elements are generally denoted by the same reference numerals.

FIG. 1 shows a cross-section of a part of a liquid crystal device 1 having liquid crystal material 5 between a bottom substrate 2 and an upper substrate 3. The liquid crystal device has picture electrodes 4 on the bottom substrate 2 and the other substrate 3. The distance between the substrates is about 0.8-10 micrometer,

The substrates 2, 3, further comprise if necessary (not shown) orientating layers and a color filter 6, comprising sub-parts 6R, 6G, 6B, relating to red green and blue parts respectively. The sub-parts are separated by spacer means 7 which also function as barriers during the color-printing of the color filter 6, comprising sub-parts 6R, 6G, 6B.

The barriers (spacers) 7 in this example are provided as lines to facilitate the filling of the liquid crystal material after the colour filter has been applied. By making the length of the barriers somewhat longer than the colour filter area the coloring materials do no mix at the end of such a line. An optional resist strip 8 in this example, which is made in the same step as the barriers 7, may also prevent such mixing of colors.

Another embodiment of the invention uses a black barrier material for the barriers (spacers) 7. In this way the barrier material can also function as a black matrix. There are several black organic resists available to serve this purpose.

Some additional spacers, continuous strips or arrays of discrete pillars could be placed in between the barriers 7 as additional spacing means.

Another embodiment of the invention is shown in FIG. 3, which shows a barrier of two materials that can be made in one mask step. The first part 7a of the barrier has an inorganic surface, while the surface of the second part 7b is fully organic. This has the advantage that after selective surface modification the (liquid) coloring material wets the anorganic part and will not wet the top organic part of the barrier 7. This can be an advantage in reducing the final layer thickness variation of the colour filter. Instead of a fully inorganic material, also an organic/inorganic composite can be used, as long as its inorganic content is sufficiently high.

The device of FIG. 4 has an optional (resist) strip (barrier) 11, provided together with the sealing edge 9. The strip 11 divides the area of the display in a first part 1a at the side of a filling hole 10 at one side of the sealing edge 9 and a second part 1b. Filling of the device with the liquid crystal material 5 can be done with a usual filling process. The larger cell gap outside the area with the color filter will give easier flow of the liquid crystal material. To prevent initial flow around the display additional transverse barrier 11 is used. It might be preferred to have the barrier not fully closing the gap between display area and edge seal to allow the liquid crystal material to fill the rim around the display at equal pace as the central part of the display (with colour filter).

In manufacturing a substrate 2 is provided with barriers 7 for the ink-jet printing, which are made equal to the required display cell gap plus the thickness of the colour filter itself (order 5-7 μm). The height of the colour filter material is between 0.5-2.0 μm, which leaves about 5 μm for the display material. An optional resist strip can be added which can be made in the same mask design as the barriers.

The wetting of the barrier material by the colour filter liquid can be prevented by a surface treatment of O₂ and CF₄, where the O₂ treatment (or the like) makes the colour. filter material to wet the (ITO) electrode and the CF₄ treatment (or the like) makes the organic barriers to be non-wetting. Because the ITO electrode is inorganic and the barrier material is organic there is a difference in the wettability between the ITO and the barrier after the O₂ and CF₄ treatment.

After supplying the coloring material a second substrate is provided on the spacer means 7.

The protective scope of the invention is not limited to the embodiments described. As mentioned in the embodiment of FIG. 2 a strip 8 may be provided temporarily. Also parts spacing elements (especially, when using roll-to-roll processes) may be provided on both substrates, e.g. elongated spacer parts which are provided in directions transverse to each other. On the other hand the function of the colour filter and ITO (electrode) can be combined by using conductive coloring material. The color filter material now does not need to be printed on top of the ITO. Now it is important that the colour filter ink is printed on top of a layer with an inorganic part, as is described.

The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. A display device (1) comprising an electro-optical medium (5) between a pair of substrates (2,3) arranged in opposite relation with respect to each other by spacer means (7), one of the substrates being provided with coloring materials within areas separated from each other by said spacer means.

2. A display device as in claim 1, in which said spacer means are opaque.

3. A display device as claimed in claim 1, said spacer means comprising a two-part structure.

4. A display device as claimed in claim 3, the part of the two-part structure at the substrate provided with coloring materials comprising opaque material.

5. A display device as claimed in claim 1, the coloring materials being conductive

6. A display device as claimed in claim 1, the display device further comprising a sealing edge (9) and a (semi-closed) barrier (11) between a filling opening (10) at one sealing edge of the display device and a part between the part of the substrate provided with coloring materials and the other sealing edges.

7. A method for manufacturing a display device (1) comprising an electro-optical medium (5) between a pair of substrates (2,3), said method comprising the steps of providing spacer means on a first substrate separating different areas from each other
supplying a coloring material to at least one area
providing a second substrate on the spacer means.

8. A method as claimed in claim 6 in which step a) comprises the steps of
a1) providing an inorganic part as part of said spacer means
a2) providing a further organic part as part of said spacer means.

9. A method as claimed in claim 6 in which step a) comprises the steps of
a1) providing an opaque part as part of said spacer means
a2) providing a further part as part of said spacer means.

10. A method as claimed in claim 7 which further comprises the step of providing a sealing edge and a barrier between a filling opening at one sealing edge of the display device and a part between the part of the substrate provided with coloring materials and the other sealing edges, filing the device with liquid crystal material and sealing the filling opening.
